(19) United States
(12) Patent Application Publication
(10) Pub. No.: US 2018/0364021 A1
(43) Pub. Date: Dec. 20, 2018

(54) SHAPE MEASURING DEVICE AND SHAPE MEASURING METHOD

(71) Applicant: OLYMPUS CORPORATION, Tokyo (JP)

(72) Inventor: Yuki TAKAHASHI, Ina-shi (JP)

(73) Assignee: OLYMPUS CORPORATION, Tokyo (JP)

(21) Appl. No.: 16/114,538

(22) Filed: Aug. 28, 2018

Related U.S. Application Data
(63) Continuation of application No. PCT/JP2017/019846, filed on May 29, 2017.

(30) Foreign Application Priority Data
Jun. 3, 2016 (JP) 2016-111783

(51) Int. Cl. G01B 5/213; G01M 11/02

(52) U.S. Cl. CPC G01B 5/213; G01B 5/008; G01M 11/0221; G01M 11/025

(57) ABSTRACT

A shape measuring device configured to measure a shape of a surface to be measured of a target object, the device includes: a holder configured to hold the target object; a sensor configured to measure a shape of the surface to be measured and output a measurement value; a sensor rotating mechanism configured to rotate the sensor about a first axis; a sensor moving mechanism configured to move the sensor on a second axis; a holder moving mechanism configured to move the holder along a third axis; and a processor configured to: calculate a shape of the surface to be measured based on the measurement value; calculate a position of a center of sphere of the surface to be measured; and control the holder moving mechanism to match the position of the center of sphere with the intersection of the first axis and the second axis.

### CROSS-REFERENCE TO RELATED APPLICATION

This application is a continuation of PCT International Application No. PCT/JP2017/019846 filed on May 29, 2017 which claims the benefit of priority from Japanese Patent Application No. 2016-111783, filed on Jun. 3, 2016, the entire contents of which are incorporated herein by reference.

### BACKGROUND

### 1. Technical Field

The present disclosure relates to a shape measuring device and a shape measuring method for measuring a shape of a curved surface in a spherical-shaped part.

### 2. Related Art

Optical lenses and processing plates to process optical lenses are typical spherical-shaped parts. In the related art, as a method of measuring a shape of these parts, for example, a contact measuring method using a contact probe disclosed in Japanese Laid-open Patent Publication No. 8-219764, and a non-contact measuring method using a laser displacement gauge disclosed in Japanese Laid-open Patent Publication Nos. 9-178439 and 2002-257511 have been proposed.

### SUMMARY

In some embodiments, provided is a shape measuring device configured to measure a shape of a surface to be measured of a target object having the surface to be measured in a spherical shape. The device includes: a holder configured to hold the target object; a sensor configured to measure a shape of the surface to be measured in a state where a pressure is applied to the surface to be measured, and output a measurement value; a sensor rotating mechanism configured to rotate the sensor about a first axis; a sensor moving mechanism configured to move the sensor on a second axis that is perpendicular to the first axis, and toward both sides of an intersection of the second axis and the first axis along the second axis; a holder moving mechanism configured to move the holder along a third axis that is parallel to a vertical direction, within a plane perpendicular to the third axis; and a processor comprising hardware, the processor being configured to: calculate a shape of the surface to be measured based on the measurement value output from the sensor; calculate a position of a center of sphere of the surface to be measured; and control the holder moving mechanism to match the position of the center of sphere with the intersection of the first axis and the second axis.

In some embodiments, provided is a shape measuring method of measuring a shape of a surface to be measured of a target object having the surface to be measured in a spherical shape by a shape measuring device that includes a sensor movable about a first axis and movable on a second axis perpendicular to the first axis. The method includes: calculating a shape of the surface to be measured based on a measurement value output from the sensor configured to measure a shape of the surface to be measured in a state where a pressure is applied to the surface to be measured; calculating a position of a center of sphere of the surface to be measured; and matching the position of the center of sphere with an intersection of the first axis and the second axis.

The above and other features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a schematic diagram illustrating a configuration of a shape measuring device according to an embodiment of the present disclosure;

FIG. 2 is a cross-section illustrating a first configuration example of a sensor included in the shape measuring device according to the embodiment of the present disclosure;

FIG. 3 is a cross-section illustrating a cross-section at a position different from that of FIG. 2 showing the first configuration example of the sensor included in the shape measuring device according to the embodiment of the present disclosure;

FIG. 4 is a flowchart illustrating a shape measuring method by the shape measuring device according to the embodiment of the present disclosure;

FIG. 5 is a flowchart illustrating a master (target object) adjusting method in the shape measuring method by the shape measuring device according to the embodiment of the present disclosure;

FIG. 6 is a schematic diagram for explaining a first example of a method of measuring a surface to be measured in the shape measuring method by the shape measuring device according to the embodiment of the present disclosure;

FIG. 7 is a graph for explaining a method of correcting a measurement value of a master in the shape measuring method by the shape measuring device according to the embodiment of the present disclosure;

FIG. 8 is a flowchart illustrating arithmetic processing and a data storage method in the shape measuring method by the shape measuring device according to the embodiment of the present disclosure;

FIG. 9 is a graph for explaining a method of correcting a measurement value of a sensor in the shape measuring method by the shape measuring device according to the embodiment of the present disclosure;

FIG. 10 is a graph for explaining a method of correcting a measurement value of the sensor in the shape measuring method by the shape measuring device according to the embodiment of the present disclosure;

FIG. 11 is a cross-section illustrating a second configuration example of the sensor included in the shape measuring device according to the embodiment of the present disclosure;

FIG. 12 is a cross-section illustrating a third configuration example of the sensor included in the shape measuring device according to the embodiment of the present disclosure;

FIG. 13 is a schematic diagram for explaining a second example of the method of measuring a surface to be measured in the shape measuring method by the shape measuring device according to the embodiment of the present disclosure;

FIG. 14 is a cross-section illustrating a fourth configuration example of sensor included in the shape measuring device according to the embodiment of the present disclosure; and

FIG. 15 is a schematic diagram for explaining a method of measuring an amount of eccentricity in the shape measuring method by the shape measuring device according to the embodiment of the present disclosure.

### DETAILED DESCRIPTION

A shape measuring device and a shape measuring method according to an embodiment of the present disclosure are explained below, referring to the accompanying drawings. The present disclosure is not limited to the following embodiment, but components in the following embodiment include ones easily replaced with by those skilled in the art or ones practically the same. Moreover, like reference symbols are assigned to like parts throughout the drawings to be referred to in the following.

Shape Measuring Device

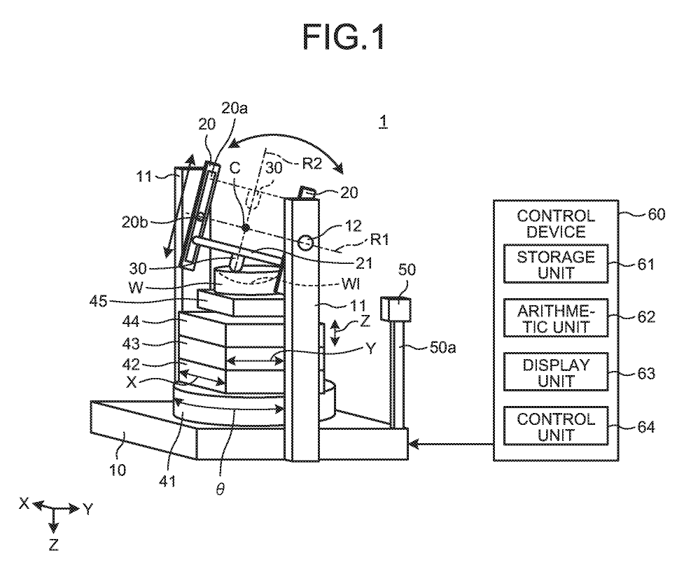

In the following, a configuration of a shape measuring device according to the embodiment of the present disclosure is explained, referring to FIG. 1 to FIG. 3 A shape measuring device 1 measures a shape of a surface to be measured in a target object that has a convex or concave spherically-shaped surface to be measured and, more specifically, measures an eccentricity of shape in a diameter direction at each point on the surface to be measured.

The shape measuring device 1 includes a base 10, a pair of supporting members 11, an encoder 12, a pair of slide rails 20, a bar 21, a sensor 30, a θ stage 41, an X stage 42, a Y stage 43, a Z stage 44, a holder 45, a temperature measuring device 50, and a control device 60 as illustrated in FIG. 1. In the following explanation, the vertical direction corresponds to a Z direction, and the horizontal plane perpendicular to the Z direction corresponds to an XY plane.

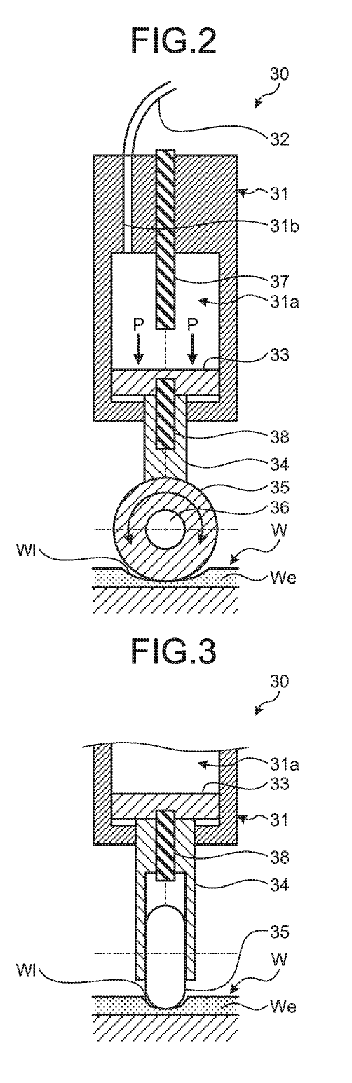

A target object W is an object that has a surface to be measured W1 of a convex or concave spherical shape in at least a part of the surface, and is a processing plate for processing (polishing) an optical lens, specifically. As described later, an elastic body We is arranged on a surface of the processing plate constituting the surface to be measured W1 (refer to FIG. 2 and FIG. 3). Although an upper surface (surface to be measured W1) of the target object W has a concave shape and a lower surface thereof has a flat shape in FIG. 1, the shape of the target object W is not particularly limited as long as at least the surface to be measured W1 has a spherical shape. Furthermore, a surface condition of the surface to be measured W1 can be rough surface or polished surface.

The base 10 is formed in a planar shape, and various kinds of parts such as the sensor 30 are arranged on the base 10. The pair of supporting members 11 are formed in a rod shape, and are arranged at positions facing each other on respective side surfaces of the base 10.

The pair of slide rails 20 are rotatably attached to the supporting members 11 through the encoder 12. The pair of slide rails 20 are arranged parallel to each other, and 360° rotatably about a center axis R1 (first axis) of the encoder 12. The encoder 12 is a rotation-angle sensing member to detect a rotation angle of the sensor 30.

The bar 21 is attached slidably along rail portions 20a that are arranged in the slide rails 20. The slide rails 20 and the bar 21 function as a “sensor moving mechanism” that moves the sensor 30 on an axis R2 (second axis) that is perpendicular to the center axis R1. An intersection of the axis R2, which is a path along which the sensor 30 can move, and the center axis R1 is a rotation center C of the sensor 30.

The bar 21 and the sensor 30 are arranged movably ranging between both sides of the rotation axis C along the axis R2. A position of the bar 21 (that is, a position of the sensor 30 on the axis R2) in the rail portion 20a is adjusted according to a global shape of the surface to be measured W1. Specifically, when the global shape of the surface to be measured W1 is a concave spherical shape, the bar 21 is arranged at a lower side to a pivot 20b, and when the global shape of the surface to be measured W1 is a convex spherical shape, the bar is arranged on an upper side to the pivot 20b.

The slide rails 20 and the bar 21 are provided with, for example, a driving device not illustrated, and a rotational movement of the slide rails 20 and a sliding movement of the bar 21 are automatically controlled by the control device 60 through this driving device. The driving device functions as a “sensor rotating mechanism” that rotates the sensor 30 about the center axis R1 through the slide rails 20.

An amount of rotational movement of the encoder 12 and a straight travel amount (a distance and a traveling direction from the pivot 20b) of the bar 21 in the slide rails 20 are output by the control device 60. Note that the rotational movement of the slide rails 20 and the sliding movement of the bar 21 in the slide rails 20 are not necessarily automatically controlled, but can be manually controlled by a user.

The sensor 30 measures the shape of the surface to be measured W1 of the target object W. The sensor 30 measures the shape of the surface to be measured W1 while applying pressure to the surface to be measured W1, unlike commonly used contact or non-contact sensors. The sensor 30 outputs the shape (measurement value) of the target object W obtained by measurement to the control device 60. A specific configuration of the sensor 30 is described later (refer to FIG. 2 and FIG. 3).

The θ stage 41 is rotatably arranged on a horizontal surface on the base 10. The θ stage 41 functions as a “holder rotating mechanism” that rotates about an axis parallel to the Z direction to change the direction of the holder 45 (that is, the target object W) relative to the bar 21.

The X stage 42, the Y stage 43, and the Z stage 44 are arranged on the θ stage 41. The X stage 42, the Y stage 43, and the Z stage 44 function as a “holder moving mechanism” that make translational movement in the respective direction of X, Y, Z on the θ stage 41, to adjust a three-dimensional position of the holder 45 (the target object W).

The θ stage 41, the X stage 42, the Y stage 43, and the Z stage 44 are provided with a driving device not illustrated, and a rotational movement of the θ stage 41 and translational movements of the X stage 42, the Y stage 43, and the Z stage 44 in respective directions are automatically controlled by the control device 60 through this driving device. Note that the rotational movement of the θ stage 41 and the translational movements of the X stage 42, the Y stage 43, and the Z stage 44 are not necessarily automatically controlled, but can be controlled manually by a user.

The holder 45 is arranged on the Z stage 44, and holds the target object W. The temperature measuring device 50 is arranged on the base 10 through leg portions 50a, and measures an ambient temperature. The ambient temperature measured by the temperature measuring device 50 is output to the control device 60.

The control device 60 controls overall operation of the shape measuring device 1. The control device 60 is constituted of, for example, a personal computer. The control device 60 includes a storage unit 61 that stores a control program for the control device 60 and various kinds of information, an arithmetic unit 62 that calculates a shape of the surface to be measured W1, a display unit 63 that displays the calculated shape of the surface to be measured W1, and a control unit 64 that collectively controls operations of these components.

The control unit 64 adjusts a position of the bar 21 in the slide rails 20, positions of the θ stage 41, the X stage 42, the Y stage 43, and the Z stage 44 to match the center of a sphere of the surface to be measured W1 with the rotation center C of the sensor 30, and controls a series of operations to measure the shape of the surface to be measured W1.

The control unit 64 measures the shape (minute projections and depressions and geometric deviations from sphericity) of the surface to be measured W1 by scanning the surface to be measured W1 with the sensor 30. As described above, the center of sphere of the surface to be measured W1 is set to match with the rotation center C of the sensor 30 by the control unit 64. Therefore, by rotating the slide rails 20 and the θ stage 41, distances from the sensor 30 to respective points on the surface to be measured W1 can be maintained constant. Thus, errors inherent to the sensor 30, that is errors caused by variations in measuring distance to the surface to be measured W1 (hereinafter, “linearity error”), with respect to the entire region of the surface to be measured W1 can be removed, and accurate shape measurement can be performed.

Error Correction Calculation for Linearity Error and Temperature Characteristic Error

When the surface to be measured W1 of the target object W has a true spherical shape, the shape measurement excluding the linearity error as described above is possible. However, when there are undulations on the surface to be measured W1, the linearity errors described above can affect measurement results of the sensor 30 (specifically, a first displacement sensor 37 described later). In addition, depending on the environment in which the shape measuring device 1 is installed, errors caused by temperature changes (hereinafter, “temperature characteristic error”) can occur.

In the present embodiment, error components (correction data) of the linearity error and the temperature characteristic error in the sensor 30 (specifically the first displacement sensor 37) are evaluated in advance and stored in the storage unit 61, and performs error correction calculation is performed using these error components with respect to easured values output from the sensor 30, thereby enabling highly accurate shape measurement. These error components are components inherent to the individual sensor 30 and, therefore, once the components are acquired and stored in the storage unit 61, it is unnecessary to acquire them again until the sensor 30 is next calibrated.

If a measured object distance to the surface to be measured W1 (distance between the sensor 30 (specifically, the first displacement sensor 37 described later) and each point on the surface to be measured W1) is changed, an error occurs between the measured object distance and a measurement value of the sensor 30. This error is the linearity error. The linearity error can be acquired from a measurement value of the sensor 30 to each measured object distance, and the acquired linearity error is stored in the storage unit 61.

Moreover, if the temperature environment is changed without changing a positional relationship between the sensor 30 (specifically, the first displacement sensor 37 described later) and the surface to be measured W1, an error occurs between a measured object distance and a measurement value of the sensor 30. This error is the temperature characteristic error. The temperature characteristic error can be acquired from a measurement value of the sensor to each measured object distance, and the acquired temperature characteristic error is stored in the storage unit 61.

Configuration of Sensor

In the following, a specific configuration of the sensor 30 included in the shape measuring device 1 is explained, referring to FIG. 2 and FIG. 3. FIG. 2 and FIG. 3 illustrate cross-sections of the sensor 30 at the time of the shape measurement of the surface to be measured W1. Furthermore, FIG. 3 illustrates a cross-section perpendicular to the cross-section illustrated in FIG. 2.

The sensor 30 is a sensor unit that includes multiple displacement sensors. The sensor 30 includes a housing 31, an air supplying tube 32, a planar member 33, a supporting member 34, a rotator 35, an encoder 36, the first displacement sensor 37, and a second displacement sensor 38.

In an inner space 31a of the housing 31, a part of the first displacement sensor 37, the planar member 33, a part of the supporting member 34, and the like are arranged. Moreover, to the inner space 31a, compressed air is supplied through an air supplying tube 31b at the time of shape measurement of the surface to be measured W1.

The air supplying tube 32 supplies compressed air to the inner space 31a of the housing 31. The air supplying tube 32 is connected to an air supply source (not illustrated) at one end, and is connected to an air supplying path 31b formed in the housing 31 at the other end. The air supplying tube 32 supplies compressed air to the inner space 31a through the air supplying path 31b at the time of shape measurement of the surface to be measured W1.

The planar member 33 is arranged in the inner space 31a, and is structured movable in the inner space 31a . One side (side facing the first displacement sensor 37) of the planar member 33 is subjected to the action of a pressure P by the compressed air supplied to the inner space 31a . That is, the planar member 33 is pressurized (pushed) by the pressure P toward the surface to be measured W1.

The supporting member 34 supports the rotator 35. One end of the supporting member 34 is fixed to the planar member 33. Furthermore, the supporting member 34 bifurcates at the other end (refer to FIG. 3), and supports the rotator 35 about an axis by an axis member (not illustrated) provided between the bifurcated portions. Inside the supporting member 34, the second displacement member 38 is arranged. Although the supporting member 34 and the planar member 33 are independently illustrated in the present embodiment as in FIG. 2 and FIG. 3, they can be structured in one unit.

The rotator 35 is a guide mechanism for guiding the sensor 30 along the surface to be measured W1. The rotator 35 is arranged at a position (end of the sensor 30) that comes in contact with the surface to be measured W1 at the time of the shape measurement of the surface to be measured W1 by the sensor 30.

The rotator 35 is constituted of a roller that has, for example, a bearing inside, and scans the surface to be measured W1, rotating about the axis member (not illustrated) at the time of the shape measurement of the surface to be measured W1. Furthermore, the rotator 35 applies a pressure to the surface to be measured W1 according to the pressure P applied to the planar member 33 described above at the time of the shape measurement of the surface to be measured W1.

In the present embodiment, the target object W is a processing plate having an elastic body We provided on its surface, and for example, minute holes or grooves and the like can be unintentionally formed on the surface to be measured W1. Accordingly, if the surface to be measured W1 is scanned, applying a pressure to the surface to be measured W1 with, for example, a common contact probe, the contact probe can be caught on the surface to be measured W1. Therefore, in the present embodiment, the rotator 35 arranged at the end of the sensor 30 is caused to function as a guide mechanism to guide the sensor 30 along the surface to be measured W1, thereby preventing from being caught on the surface to be measured W1, and enabling the sensor 30 to scan smoothly on the surface to be measured W1.

The encoder 36 measures a rotation angle of the rotator 35 from a predetermined position, and is arranged at a position of the rotation axis of the rotator 35. The rotation angle measured by the encoder 36 is output to the control device 60.

The first displacement sensor 37 measures the shape of the surface to be measured W1. The first displacement sensor 37 is arranged at a position facing the planar member 33 at a predetermined distance, and measures the shape of the surface to be measured W1 by detecting displacement of the planar member 33. The displacement of the planar member 33 measured by the first displacement sensor 37 is output to the control device 60.

As the first displacement sensor 37, for example, a non-contact laser displacement gauge that measures a displacement by triangulation, or a contact gauge can be used.

The second displacement sensor 38 measures an amount of eccentricity of the rotator 35. The second displacement sensor 38 is arranged at a position facing the rotator 35 at a predetermined distance, and detects a displacement of a periphery of the rotator 35 to measure an amount of eccentricity of the rotator 35. The amount of eccentricity of the rotator 35 measured by the second displacement sensor 38 is output to the control device 60.

As the second displacement sensor 38, for example, a non-contact laser displacement gauge that measures a displacement by triangulation, or a contact gauge can be used.

In the present embodiment, an amount of eccentricity of the rotator 35 is acquired (calculated) by the second displacement sensor 38 in synchronization with the shape measurement of the surface to be measured W1 by the first displacement sensor 37, and a measurement value of the first displacement sensor 37 is corrected based on the amount of eccentricity. Thus, even when wobbling occurs in rotation due to a minute undulation or the like included in the shape of the rotator 35, a measurement error can be prevented.

The shape measuring device 1 having the sensor 30 as described above performs measurement while replicating a state at the time of processing an optical lens when measuring the surface to be measured W1 of the target object W. That is, the shape measuring device 1 performs measurement of the shape, applying a pressure equivalent to a pressure acting on a surface of a processing plate (the target object W) when processing an optical lens, to the surface to be measured W1. Thus, the shape of the surface to be measured W1 is measured in a state in which a pressure similar to that applied during an optical lens is being processed is applied to a processing plate (the target object W).

The amount of pressure to be applied at the time of shape measurement of the surface to be measured W1 is calculated empirically in advance before the shape measurement of the surface to be measured W1. Specifically, from a ratio between shapes of a processing plate (the target object W) that is actually used for processing and an optical lens to be processed, a force per unit area acting on the processing plate at the time of processing the optical lens can be calculated as the amount of pressure to be applied. The force per unit area acting on the processing plate at the time of processing the optical lens is a force per unit area when the optical lens and the processing plate come into contact with each other on the entire surface and the optical lens becomes its final shape (right before the processing is finished).

The amount of pressure to be applied at the time of the shape measurement of the surface to be measured W1 is preferable to be the same as a pressure acting on a processing plate (the target object W) at the time of processing an optical lens, but some errors or the like can be included.

Shape Measuring Method

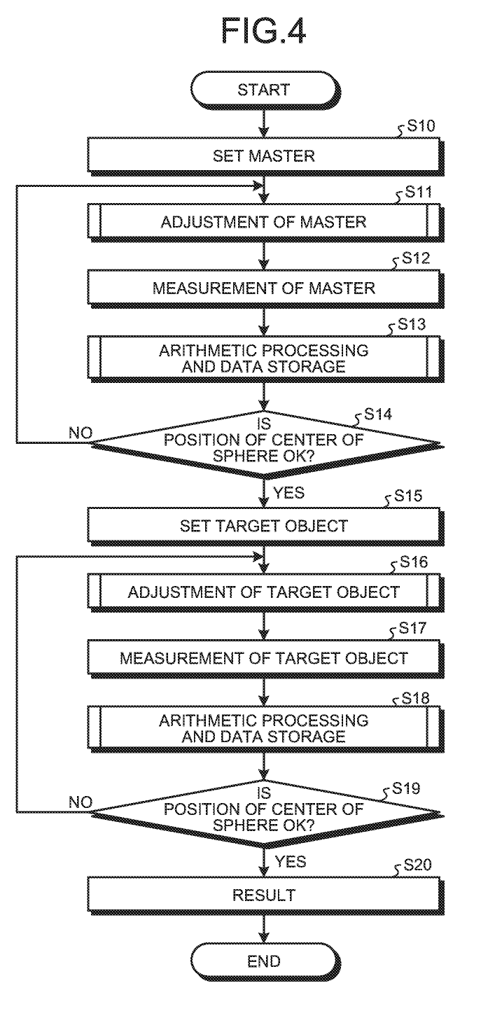

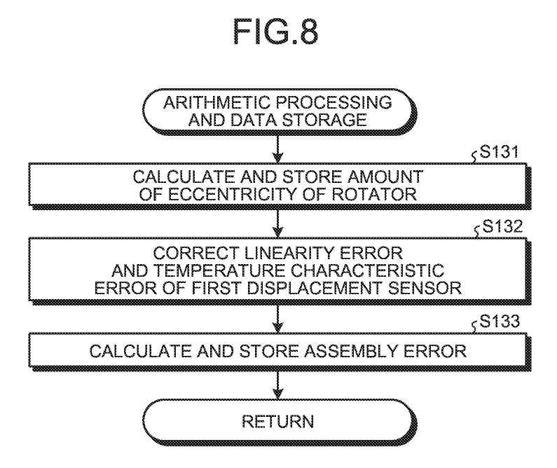

In the following, a shape measuring method using the shape measuring device 1 according to the present embodiment is explained, referring to FIG. 4 to FIG. 10.

First, a master having a surface to be measured in a true spherical shape is set in the holder 45 (step S10). In the following explanation, the surface to be measured of the master is assumed to be a convex spherical shape, but respective steps can be performed similarly also when it is in a concave spherical shape.

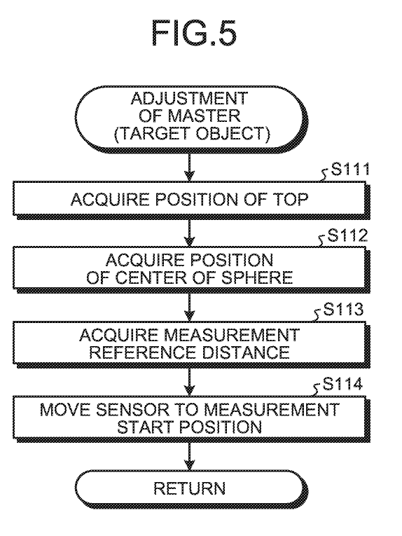

Subsequently, various adjustments are performed for the master (step S11). In the following, details of a master adjusting method at this step are explained, referring to FIG. 5.

First, the θ stage 41, the X stage 42, the Y stage 43, and the Z stage 44 are adjusted by automatic control by the control device 60 or by manual control by a user, to acquire a position of a top of the master (step S111)

Subsequently, the Z stage 44 is adjusted by the automatic control by the control device 60 or the manual control by the user such that the center of sphere of the master matches with the rotation center C of the sensor 30, to acquire a position of the center of sphere of the master (step S112).

Subsequently, the position of the bar 21 in the slide rails 20 is adjusted by the automatic control by the control device 60 or the manual control by the user to make the distance between the sensor 30 and the top of the master be a measurement reference distance set in the individual sensor 30 (step S113).

Finally, the driving device in the slide rail 20 is rotated by the automatic control by the control device 60 or the manual control by the user, to move the sensor 30 to a measurement start position (step S114). The processing returns to the main routine (refer to FIG. 4).

Following step S11, the slide rails 20 are rotated by the automatic control by the control device 60 through the driving device provided in the slide rail 20, to rotate the sensor 30 about a center axis R1 from the measurement start position to a measurement end position, and the measurement of the surface to be measured of the master is performed (step S12).

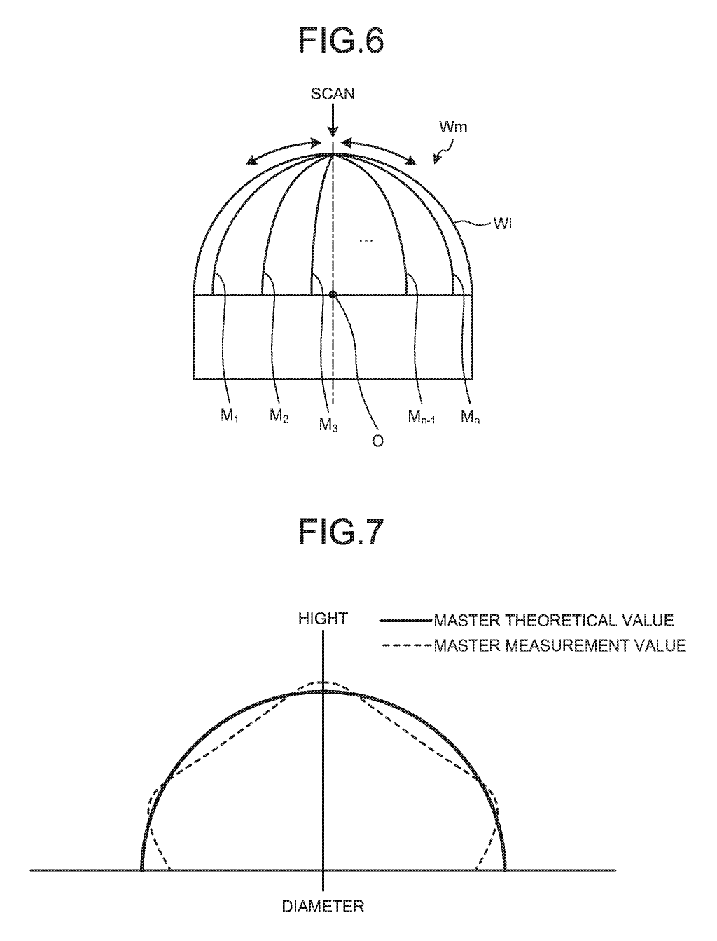

As a measuring method (scanning method) of a surface to be measured of the master at this step, for example, a method illustrated in FIG. 6 is applicable. In the example of FIG. 6, by rotating the driving device in the slide rail 20 in a state in which the sensor 30 is in contact with one point on a semicircumference M₁ of the surface to be measured W1 of a master Wm, the semicircumference M₁ scanned. Subsequently, the θ stage 41 is rotated to shift the contact point of the sensor 30, and by rotating the driving device in a state in which the sensor 30 is in contact with one point on a semicircumference M₂, the semicircumference M₂ is scanned. Similarly, by repeating scanning of semicircumferences M₃ to Mₙ, shapes of the respective semicircumferences M₃ to Mₙ can be measured.

Following step S12, the arithmetic unit 62 acquires measurement amounts (a displacement amount of the first displacement sensor 37, a displacement amount of the second displacement sensor 38, a rotation amount of the encoder 36), a rotation amount of the encoder 12, a rotation amount of the θ stage 41, and a temperature measurement value output from the temperature measuring device 50, and performs arithmetic processing to calculate the shape of the surface to be measured W1 by correcting a measurement value of the surface to be measured W1, and stores an arithmetic result in the storage unit 61 (step S13).

At this step, specifically, the arithmetic unit 62 performs calculation of an eccentricity error amount of the rotator 35 and correction of the linearity error and the temperature characteristic error of the first displacement sensor 37 for a measurement value of the master Wm. In the following, details of the processing are explained, referring to FIG. 7 to FIG. 10.

In FIG. 7, a solid line shows a theoretical value of the shape of the surface to be measured W1 of the master Wm, and a broken line shows a measurement value. The surface to be measured W1 of the master Wm is in a true spherical shape formed at a higher accuracy than an intended measurement accuracy. Therefore, a difference between the theoretical value and the measurement value shown in FIG. 7 can be regarded as a measurement error in the shape measuring device 1 (an assembly error, an eccentricity error of the rotator 35, a linearity error, a temperature characteristic error).

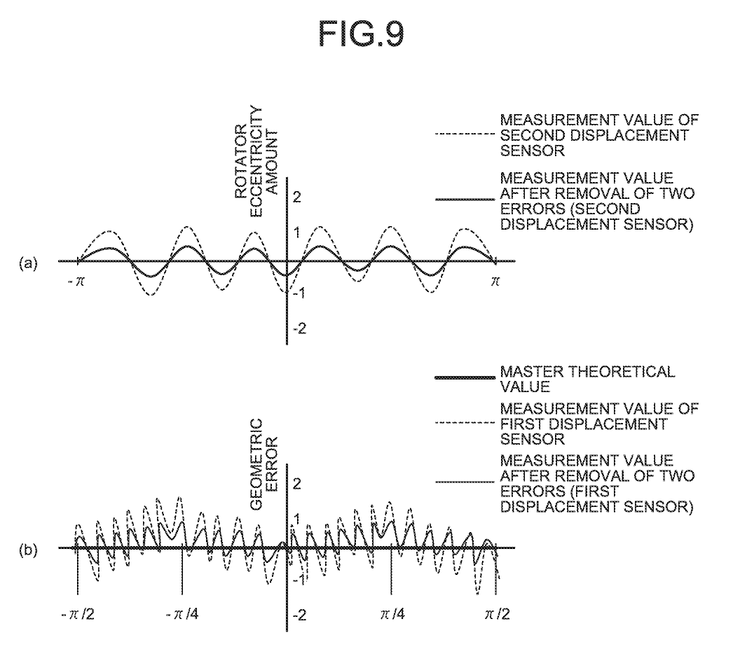

The arithmetic unit 62 of the control device 60 first calculates an amount of eccentricity of the rotator 35 and stores it (step S131). At this step, the arithmetic unit 62 corrects two kinds of errors of the linearity error (measurement error per measuring distance) and the temperature characteristic error stored in advance in the storage unit 61 to remove the errors as illustrated in (a) of FIG. 9 for a measurement value (measurement value of the second displacement sensor) of the second displacement sensor 38 and the encoder 36 synchronously output. A measurement value after removal of these two kinds of errors is the amount of eccentricity (eccentricity error amount) of the rotator 35. The arithmetic unit 62 stores data of the amount eccentricity thus acquired in the storage unit 61.

Subsequently, the arithmetic unit 62 corrects the linearity error and the temperature characteristic error of the first displacement sensor 37 (step S132). At this step, the arithmetic unit 62 corrects two kinds of errors of the linearity error (measurement error per measuring distance) and the temperature characteristic error stored in advance in the storage unit 61 to remove the errors as shown in (b) of FIG. 9 for a measurement value (measurement value of the first displacement sensor) of the first displacement sensor 37.

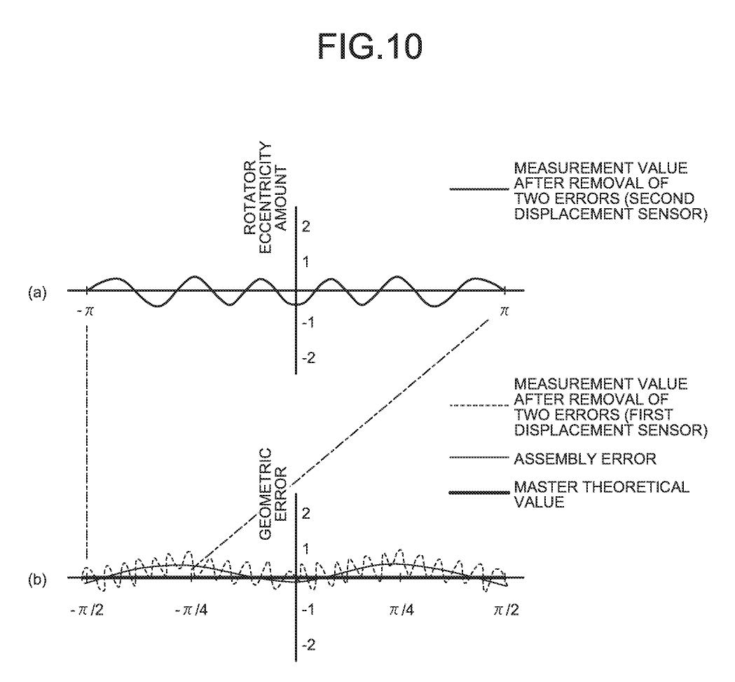

Subsequently, the arithmetic unit 62 calculates an assembly error of facilities and store it (step S133). At this step, the arithmetic unit 62 corrects an amount of eccentricity of the rotator 35 calculated at step S131 as illustrated in FIG. 10 for a measurement value of the first displacement sensor 37 after removal of the two kinds of errors corrected at step S132 (refer to (b) in FIG. 9). Thus, the assembly error of facilities relative to the master theoretical error is calculated. The arithmetic unit 62 stores data of the assembly error thus calculated in the storage unit 61.

In (a) of FIG. 9 and (a) of FIG. 10, vertical axes of graphs are for an amount of eccentricity [μm], and horizontal axes of the graphs are for a rotation angle [θ] of the rotator 35. Moreover, in (b) of FIG. 9 and (b) of FIG. 10, vertical axes of graphs are for a geometric error [μm], and horizontal axes of the graph are for a measurement angle [θ] of the target object W. Furthermore, in FIG. 10, a case in which a length of the periphery of the rotator 35 is ¼ of a measured length of the target object W is shown as an example. That is, in the example of FIG. 10, an assembly error corresponding to ¼ of the measured length of the target object W is calculated by using the amount of eccentricity corresponding to one rotation of the rotator 35.

Subsequently to step S13, the control unit 64 determines whether a center of sphere O of the surface to be measured W1 matches with the rotation center C (refer to FIG. 1) of the sensor 30 based on the shape of the surface to be measured W1 calculated at step S13 (step S14).

When the center of sphere O of the surface to be measured W1 does not match with the rotation center C of the sensor 30 (step S14: NO), it returns to step S11 and adjustment of the master Wm is performed again.

On the other hand, when the center of sphere O of the surface to be measured W1 matches with the rotation center C of the sensor 30 (step S14: YES), the master Wm is removed from the holder 45, and the target object W is set in the holder 45 (step S15). At this time, a measurement value of the master Wm in a state in which the center of sphere O of the surface to be measured W1 matches with the rotation center C of the sensor 30 is to be a reference value when measuring the target object W.

Subsequently, various adjustments of the target object W are performed (step S16). An adjusting method of the target object W at this step is the same as that of step S11 (refer to FIG. 5).

Subsequently, measurement of the surface to be measured W1 of the target object W is performed by automatic control of the control device 60 (step S17). A measuring method of the surface to be measured W1 of the target object W at this step is the same as that of step S12 (refer to FIG. 6).

Subsequently, the measurement values (the displacement value of the first displacement sensor 37, the displacement value of the second displacement sensor 38 , the rotation amount of the encoder 36) output from the sensor 30, the rotation amount of the encoder 12, the rotation amount of the θ stage 41, and the temperature measurement value output from the temperature measuring device 50 are acquired, and the measurement value of the surface to be measured W1 of the target object W is corrected to perform arithmetic processing to calculate the shape of the surface to be measured W1, and data of the arithmetic result is stored in the storage unit 61 (step S18).

At this step, specifically, the arithmetic unit 62 performs calculation of an amount of eccentricity (the eccentricity error amount) of the rotator 35 and correction of the linearity error and the temperature characteristic error of the first displacement sensor 37 for the measurement value of the surface to be measured W1 of the target object W, similarly to step S13. Subsequently, the arithmetic unit 62 corrects the amount of eccentricity of the rotator 35 from corrected data, and finally corrects the value of the assembly error calculated at step S13, thereby correcting the assembly error in the shape measuring device 1. Thus, a measurement value (corrected measurement value) of the surface to be measured W1 from which the assembly error, the eccentricity error of the rotator 35, the linearity error, and the temperature characteristic error are removed can be acquired.

Subsequently, the control unit 64 determines whether the center of sphere of the surface to be measured W1 matches with the rotation center C of the sensor 30 (refer to FIG. 1) based on the shape of the surface to be measured W1 calculated at step S18 (step S19).

When the center of sphere O of the surface to be measured W1 does not match with the rotation center C of the sensor 30 (step S19: NO), it returns to step S16, and the adjustments of the target object W are performed again.

On the other hand, when the center of sphere O of the surface to be measured W1 matches with the rotation center C of the sensor 30 (step S19: YES), the control unit 64 outputs data expressing the shape of the surface to be measured W1 calculated at step S18 to the display unit 63 to display the shape of the surface to be measured W1 as a measurement result (step S20). Thus, the shape measuring method by the shape measuring device 1 is finished.

As explained above, according to the present embodiment, shape measurement is performed by scanning the surface to be measured W1, applying a pressure thereto. Therefore, even when a processing plate having a surface on which the elastic body We is arranged is measured as the target object W, an actual shape at the time of processing can be measured accurately.

Moreover, according to the present embodiment, the sensor 30 is configured movable along the rail portions 20a of the slide rails 20, and the sensor 30 is rotated in a state in which the center of sphere O of the surface to be measured W1 is matched with the rotation center C of the sensor 30. Therefore, measurement can be performed while keeping the measuring distance relative to the surface to be measured W1 substantially constant, regardless of the shape of the surface to be measured W1 of the target object W being a convex shape or a concave shape, or regardless of the radius of curvature. Therefore, the linearity error in a measurement value can be suppressed to significantly small.

Furthermore, according to the present embodiment, a linearity error and a temperature characteristic error caused by a minute undulation on the surface to be measured W1 are removed by the arithmetic processing, and the accuracy in measurement of a shape of the surface to be measured W1 of the target object W can be thereby improved.

Moreover, according to the present embodiment, an assembly error in the shape measuring device 1 is calculated by performing measurement using the master Wm having the surface to be measured W1 in a true spherical shape, and the assembly error is removed by a measurement value of the target object W, thereby enabling further highly accurate shape measurement.

Furthermore, in the present embodiment, because the rotator 35 is structured with a roller, the rotator 35 is resistant to wear, and there is an advantage that it has high durability.

First Modification

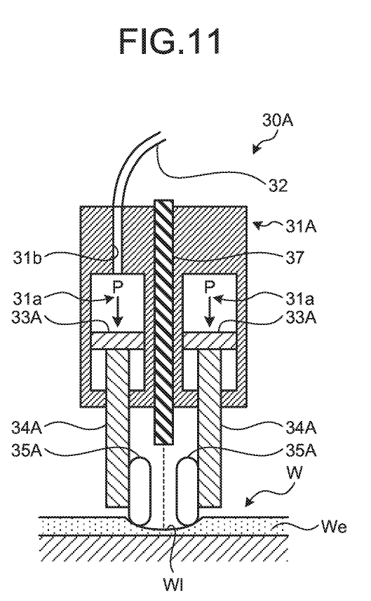

In the embodiment described above, the case in which the sensor of the shape measuring device 1 has one rotator 35 has been explained, but more than one rotator can be provided as illustrated in FIG. 11.

A sensor 30A in a first modification includes two units each of planar members 33A, supporting members 34A, and rotators 35A in the inner space 31a of a housing 31A, and includes only one displacement sensor (only the first displacement sensor 37). The first displacement sensor 37 in the sensor 30A is arranged between the two rotators 35A. The first displacement sensor 37 measures a displacement of the surface to be measured W1 by irradiating light beams to the surface to be measured W1 through a gap between the two rotators 35A.

The shape measuring device according to the first modification having the sensor 30A as described above directly measures the shape of the surface to be measured W1, by the first displacement sensor 37, applying to a pressure to the surface to be measured W1 by the two rotators 35A as illustrated in FIG. 11 to deform a surface thereof at the time of shape measurement of the surface to be measured W1.

That is, the shape measuring device according to the first modification measures a shape of the surface to be measured W1 without performing correction of an eccentricity of the rotator 35 using the second displacement sensor 38 as in the shape measuring device 1 and, therefore, can measure an actual shape of the surface to be measured W1 of the target object W accurately by a simpler method.

In the shape measuring device according to the first modification, if a gap between the two rotators 35A is too wide, a measured point of the first displacement sensor 37 is restored by the elasticity of the target object W. Therefore, the gap between the two rotators 35A is preferable to be set as narrow as not to restore the form.

Second Modification

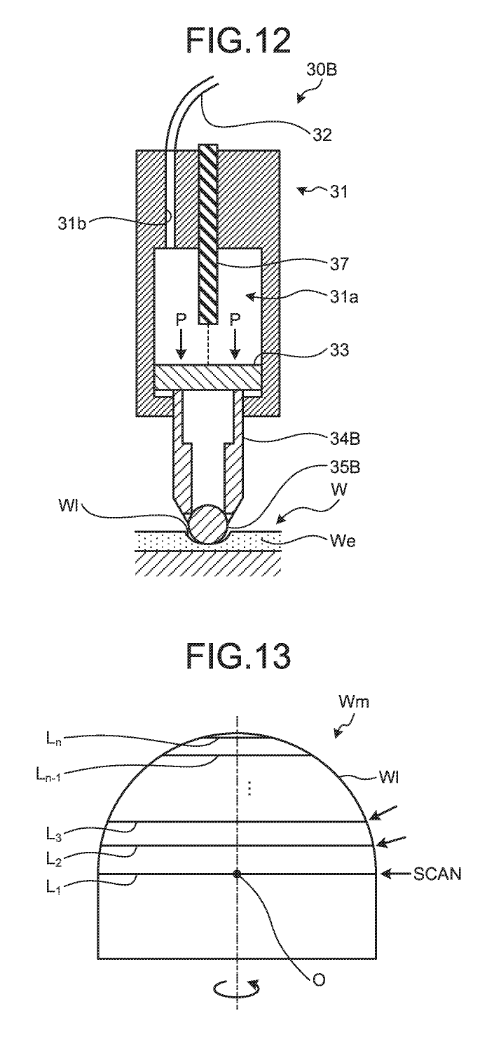

In the embodiment described above, the case in which the rotator 35 in the sensor 30 of the shape measuring device 1 is structured with a roller has been explained, but the rotator can be structured with one other than a roller as illustrated in FIG. 12.

In a sensor 30B in a second modification, a rotator 35B is structured with a steel ball, and only one displacement sensor (only the first displacement sensor 37) is provided. The steel ball constituting the rotator 35B is a true sphere with a small eccentricity (for example, 0.5 μm or less). Moreover, the sensor 30B is configured such that the first displacement sensor 37 measures a displacement of the planer member 33 similar to the sensor 30 described above. The rotator 35B is supported by a cylindrical supporting member 34B.

A shape measuring device according to the second modification having the sensor 30B as described above uses a steel ball with a small eccentricity as the rotator 35B and, thereby, can measure a shape of the surface to be measured W1 without performing correction of the eccentricity of the rotator 35 using the second displacement sensor 38 as in the shape measuring device 1. Therefore, an actual shape of the surface to be measured W1 of the target object W can be measured accurately by a simpler method.

Furthermore, by using a freely rotatable steel ball as the rotator 35B, flexibility of a scanning method also increases. That is, the shape measuring device according to the second modification having the sensor 30B can apply a scanning method as illustrated in FIG. 13 in addition to the scanning method illustrated in FIG. 6 described above.

In an example in FIG. 13, a circumference L₁ is scanned by rotating the θ stage 41 by one revolution in a state in which the sensor 30B is in contact with the surface to be measured W1 of the master Wm at one point on the circumference L₁. Subsequently, the driving device provided in the slide rail 20 is rotated to shift the contact point of the sensor 30B, and a circumference L₂ is scanned by rotating the θ stage 41 by one revolution in a state in which the sensor 30B is in contact with one point on the circumference L₂. Similarly, by repeating scanning of circumferences L₃ to Lₙ by the sensor 30B, shapes of the respective circumferences L₃ to Lₙ can be measured.

Third Modification

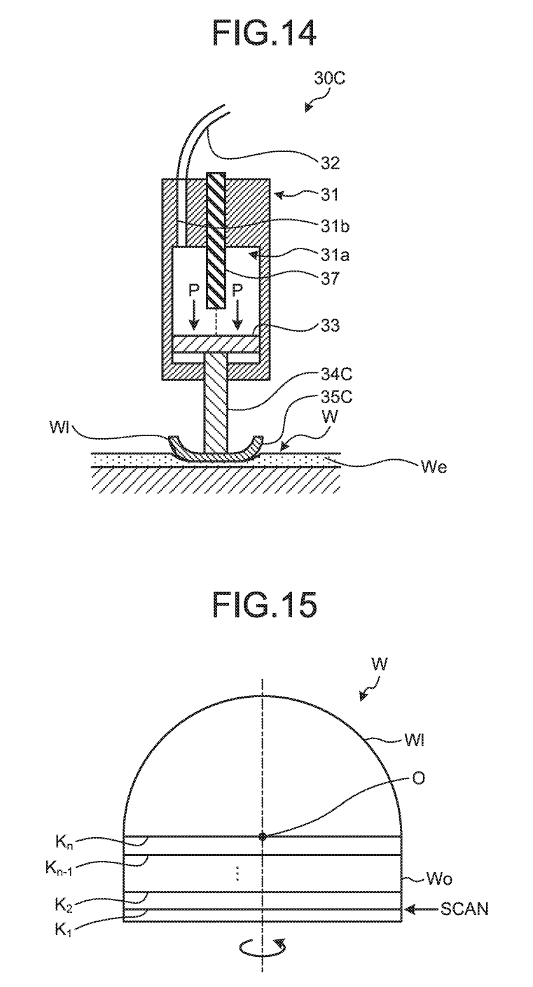

In the embodiment described above, the case in which the guide mechanism in the sensor 30 of the shape measuring device 1 is structured with a rotator (the rotator 35) has been explained, but the guide mechanism can be structured one other than a rotator as illustrated in FIG. 14.

In a sensor 30C in a third modification, the guide mechanism is structured not with a rotator but with a planar member 35C, both ends of which curve toward the housing 31, and only one displacement sensor (only the first displacement sensor 37) is provided. The planar member 35C is supported by a rod-shaped supporting member 34C.

A shape measuring device according to the third modification having the sensor 30C as described above uses the planar member 35C as the guiding mechanism, and thereby measures a shape of the surface to be measured W1 without performing correction of an eccentricity of the rotator 35 using the second displacement sensor 38 as in the shape measuring device 1. Therefore, an actual shape of the surface to be measured W1 of the target object W can be measured accurately by simpler method and configuration.

Fourth Modification

In the second modification described above, the case in which the shape of the surface to be measured (spherical surface) W1 of the target object W is measured by the shape measuring device has been explained (refer to FIG. 13), but the shape measuring device according to the second modification can measure an amount of eccentricity of a periphery with respect to the surface to be measured W1 of the target object W also.

A measuring method of an amount of eccentricity in a fourth embodiment is performed after step S19 (after the center of sphere O of the surface to be measured W1 of an target object is determined to match with the rotation center C of the sensor 30 (refer to FIG. 1)) in FIG. 4. FIG. 15 is a schematic diagram for explaining a method of measuring an amount of eccentricity.

First, the shape measuring device measures a periphery Wo of the target object W. Specifically, a circumference K₁ is scanned by rotating the θ stage 41 by one revolution in a state in which the sensor 30 (the rotator 35) is in contact with one point on the circumference K₁ on the periphery Wo of the target object W. Subsequently, the contact point of the sensor 30 is shifted by driving the Z stage 44, and a circumference K₂ is scanned by rotating the θ stage 41 by one revolution in a state in which the sensor 30 (the rotator 35) is in contact with one point on the circumference K₂. Similarly, by repeating scanning of circumferences K₃ to Kₙ by the sensor 30, shapes of the respective circumferences K₁ to Kₙ can be measured.

The arithmetic unit 62 calculates an amount of eccentricity (deviation in the XY direction (shift amount), an amount t of tilt the periphery Wo (tilt amount)) of the periphery Wo with respect to the surface to be measured W1 based on the measurement value of the periphery Wo of the target object W and the data acquired at step S18.

As described above, the shape measuring device 1 and the shape measuring method have been specifically explained by the embodiments of the present disclosure, but the gist of the present disclosure is not limited to these descriptions, and should be interpreted widely based on descriptions of claims. Moreover, it is needless to say that one including various modifications, alterations, and the like based on these descriptions are also included in the gist of the present disclosure.

For example, although the shape measuring device described above uses compressed air to apply a pressure to the surface to be measured W1, a pressure can be applied by a small servo or a spring.

Furthermore, although the case in which a measurement value of the first displacement sensor 37 is corrected based on an amount of eccentricity acquired by the second displacement sensor 38 has been explained for the shape measuring device described above, the correction is not necessarily required to be performed, for example, when the amount of eccentricity of the rotator 35 is very small (for example, 0.5 μm or smaller, or the like). That is, the shape measuring device can be configured without the second displacement sensor 38, and not to perform correction based on an amount of eccentricity when the rotator 35 having very small eccentricity.

According to some embodiments, because shape measurement is performed by scanning while applying a pressure to a surface to be measured, even when a processing plate having a surface on which an elastic body is arranged is measured as a target object, an actual shape at the time of processing can be measured accurately.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A shape measuring device configured to measure a shape of a surface to be measured of a target object having the surface to be measured in a spherical shape, the device comprising:
a holder configured to hold the target object;
a sensor configured to measure a shape of the surface to be measured in a state where a pressure is applied to the surface to be measured, and output a measurement value;
a sensor rotating mechanism configured to rotate the sensor about a first axis;
a sensor moving mechanism configured to move the sensor on a second axis that is perpendicular to the first axis, and toward both sides of an intersection of the second axis and the first axis along the second axis;
a holder moving mechanism configured to move the holder along a third axis that is parallel to a vertical direction, within a plane perpendicular to the third axis; and
a processor comprising hardware, the processor being configured to:
calculate a shape of the surface to be measured based on the measurement value output from the sensor;
calculate a position of a center of sphere of the surface to be measured; and
control the holder moving mechanism to match the position of the center of sphere with the intersection of the first axis and the second axis.

2. The shape measuring device according to claim 1, wherein
the target object is a processing plate for processing an optical lens, and
an elastic body is arranged on a surface of the processing plate constituting the surface to be measured.

3. The shape measuring device according to claim 2, wherein
the sensor is configured to apply a pressure that has been calculated in advance and that is equivalent to a pressure acting on a surface of the processing plate when processing the optical lens, to the surface to be measured.

4. The shape measuring device according to claim 1, wherein
the sensor includes a guiding mechanism configured to guide the sensor along the surface to be measured, at a position in contact with the surface to be measured.

5. The shape measuring device according to claim 4, wherein
the guide mechanism includes at least one rotator.

6. The shape measuring device according to claim 5, wherein
the processor is further configured to calculate an amount of eccentricity of the at least one rotator, and correct the measurement value output from the sensor based on the amount of eccentricity.

7. The shape measuring device according to claim 1, wherein
a position of the sensor on the second axis is adjustable according to a global shape of the surface to be measured.

8. The shape measuring device according to claim 1, further comprising
a holder rotating mechanism configured to rotate the holder about the third axis.

9. The shape measuring device according to claim 1, wherein
the processor is further configured to calculate an assembly error in the shape measuring device from a measurement value that is obtained by measuring a master having a true sphere in at least a part of a surface of the master by the sensor, and correct the measurement value of the surface to be measured output from the sensor by using the assembly error.

10. The shape measuring device according to claim 1, further comprising
a storage configured to store information relating to measuring distance that is acquired in advance for the shape measuring device, wherein
the processor is further configured to correct an error of the measurement value derived from a distance between the sensor and the surface to be measured by using the information relating to measuring distance.

11. The shape measuring device according to claim 1, further comprising
a temperature measuring device configured to measure an ambient temperature of the shape measuring device, and
a storage configured to store information relating to temperature characteristic that is acquired in advance for the shape measuring device, wherein
the processor is further configured to correct an error of the measurement value derived from a change of the ambient temperature by using the information relating to temperature characteristic.

12. The shape measuring device according to claim 1, wherein
the processor is further configured to calculate an amount of eccentricity of a periphery of the target object with respect to the surface to be measured based on measurement values of the surface to be measured and of the periphery of the target object measured by the sensor.

13. A shape measuring method of measuring a shape of a surface to be measured of a target object having the surface to be measured in a spherical shape by a shape measuring device that includes a sensor movable about a first axis and movable on a second axis perpendicular to the first axis, the method comprising:
calculating a shape of the surface to be measured based on a measurement value output from the sensor configured to measure a shape of the surface to be measured in a state where a pressure is applied to the surface to be measured;
calculating a position of a center of sphere of the surface to be measured; and
matching the position of the center of sphere with an intersection of the first axis and the second axis.

14. The shape measuring method according to claim 13, further comprising
Calculating the target object being a processing plate for processing an optical lens, the processing plate having a surface on which an elastic body is arranged.

15. The shape measuring method according to claim 14, further comprising
applying a pressure that has been calculated in advance and that is equivalent to a pressure acting on a surface of the processing plate when processing the optical lens, to the surface to be measured.

16. The shape measuring method according to claim 13, further comprising:
calculating an amount of eccentricity of a rotator that is arranged at a position in contact with the surface to be measured in the sensor; and
correcting the measurement value output from the sensor based on the amount of eccentricity.

17. The shape measuring method according to claim 13, further comprising
adjusting a position of the sensor on the second axis according to a global shape of the surface to be measured.

18. The shape measuring method according to claim 13, further comprising:
measuring a true spherical surface of a master having the true spherical surface in at least a part of a surface of the master by the sensor to output a measurement value of the true spherical surface of the master;
calculating an assembly error in the shape measuring device based on the output measurement value of the true spherical surface of the master; and
correcting the measurement value of the surface to be measured output from the sensor by using the calculated assembly error.

19. The shape measuring method according to claim 13, further comprising
correcting an error of the measurement value derived from a distance between the sensor and the surface to be measured by using information relating to measuring distance that is acquired in advance for the shape measuring device.

20. The shape measuring method according to claim 13, further comprising
correcting an error of the measurement value derived from a change of an ambient temperature of the shape measuring device by using information relating to temperature characteristic that is acquired in advance for the shape measuring device.

21. The shape measuring method according to claim 13, further comprising
calculating an amount of eccentricity of a periphery of the target object with respect to the surface to be measured based on measurement values of the surface to be measured and of the periphery of the target object measured by the sensor.
